(19) United States
(12) Patent Application Publication
(10) Pub. No.: US 2004/0222577 A1
(43) Pub. Date: Nov. 11, 2004

(54) Air spring having an integrated compression stop and method of making the same

(76) Inventors: Matthias Moritz, Neustadt (DE); Holger Oldenettel, Resse (DE)

Correspondence Address: Walter Ottesen, Patent Attorney, P.O. Box 4026, Gaithersburg, MD, 20885-4026, US

(21) Appl. No.: 10/841,444

(22) Filed: May 10, 2004

(30) Foreign Application Priority Data
May 8, 2003 (DE) 103 20 502.0

(51) Int. Cl. F16F 9/04

(52) U.S. Cl. 267/64.27

(57) ABSTRACT

An air spring (4) includes an air spring cover (8), a roll-off piston (10) and an air spring flexible member (14). The flexible member (14) is attached between the cover (8) and the piston (10) by clamp rings (12a, 12b). An ancillary spring pot (28) accommodates a compression stop (30). The connection of the ancillary pot (28) on the air spring cover (8) is realized in that the air spring cover (8) is made of sheet metal and has a side facing toward the interior space (22) of the air spring. On this side, the air spring cover has a hollow-cylindrical region with a support (24) for the press-fit accommodation of the ancillary spring pot (28). The diameter of the hollow-cylindrical region of the air spring cover (8) is slightly greater than the diameter of the ancillary spring pot (28). The hollow-cylindrical region includes a peripherally-extending groove (26) for accommodating an outwardly formed edge (34) of the pot (28). The ancillary spring pot (28) is clamped by reducing the hollow-cylindrical region of the air spring cover (8) and/or of the outer edge of its groove (26).

### CROSS REFERENCE TO RELATED APPLICATION

This application claims priority of German patent application no. 103 20 502.0, filed May 8, 2003, the entire content of which is incorporated herein by reference.

### BACKGROUND OF THE INVENTION

An integrated compression stop is standard equipment of an air spring in present day air springs. In this connection, reference can be made to U.S. Pat. No. 6,336,610 and United States patent publication 2002/0011697 and German patent publication 199 59 839.

In such air springs, the rubber buffer functions as a compression stop (additional spring) and must be held in a pot. This pot is usually mounted on the lower side of the air spring cover.

In the case of a helical spring, the pot, which functions to receive the rubber buffer, is on the lower side of the spring plate. In this connection, reference can be made to German patent publication 197 19 301. However, this publication does not explain in any detail as to how this buffer pot can be secured to the lower side of the spring plate. If the air spring cover or spring plate and the buffer pot are made of embossed steel sheet metal, then the connection of the two parts usually takes place via a welding operation.

In the above, it cannot be prevented that the surface protection of the metal parts to be joined becomes damaged because of the welding operation. Also, a weld distortion cannot be precluded.

In U.S. Pat. No. 6,366,610, the buffer pot and the air spring cover form a common pressure die casting. FIGS. 4 and 7 of German patent publication 199 59 839 likewise disclose a pressure die casting air spring cover having an integrated buffer pot.

In lieu of the housing, which surrounds the buffer above and laterally, the exposed stop buffer can be vulcanized about the embossed plate. In this connection, reference can be made to FIGS. 1 to 3, 5 and 6 of German patent publication 199 59 839.

In lieu of manufacturing an air spring cover having an integrated buffer pot (ancillary spring pot) as a pressure die casting made of metal such as aluminum, United States patent publication 2002/0011697 suggests a corresponding injection molded part made of plastic to which reinforcement materials can be added such as glass fibers.

### SUMMARY OF THE INVENTION

It is an object of the invention to provide a cost-effective attachment of the additional spring pot to the cover of an air spring.

The air spring of the invention includes: an air spring cover made of sheet metal; a roll-off piston; an air spring flexible member; first and second clamp rings for clamping the flexible member pressure-tight to the air spring cover and the roll-off piston, respectively; the air spring cover, the roll-off piston and the flexible member conjointly defining an air spring interior space; the air spring cover having a side facing toward the interior space and the side defining a hollow cylindrical region of a first diameter; a compression stop assembly mounted in the air spring cover and the compression stop assembly including an ancillary spring pot and an impact buffer disposed therein; and, the ancillary spring pot having a second diameter and the first diameter being slightly greater than the second diameter.

The air spring cover as well as the ancillary spring pot are manufactured of shaped sheet metal, preferably, steel sheet metal. These components are cost effective. The press-fit seating of the ancillary spring pot in the hollow-cylindrical recess of the cover does not require complex assembly work.

The reliable hold of the ancillary spring pot on the air spring cover can be improved when the hollow-cylindrical region of the cover has a circumferentially extending groove and the pot has an edge shaped to extend outwardly.

The method of the invention for attaching the ancillary spring pot is also suitable for spring struts having an integrated shock absorber.

The ancillary pot is clamped by reducing the cylindrical region of the air spring cover and/or of the outer edge of its groove. This cross-sectional reduction of the air spring cover is preferably realized by a forming process.

The forming process is realized by rolling. For this purpose, a press roller deforms the material. Here, the clamping contour of the air spring cover is rolled simultaneously. Alternatively, this forming process can take place during clamping the air spring flexible member.

A general cost reduction results because of the cost-effective assembly process.

Damage of the surface protection is avoided. Also, there is no distortion which is usual for a weld seam. Sheet metal is cost effective and permits a high degree of forming and provides high strength.

### BRIEF DESCRIPTION OF THE DRAWINGS

The invention will now be described with reference to the drawings wherein:

FIG. 1 is a detailed view, in longitudinal section, of an air spring strut in advance of the attachment of an ancillary spring pot; and,

FIG. 2 shows the right half of an air spring strut, in longitudinal section, with the assembled ancillary spring pot.

### DESCRIPTION OF THE PREFERRED EMBODIMENTS OF THE INVENTION

An air spring strut 2 comprises an air spring 4 and a shock absorber 6. The air spring 4 essentially comprises an air spring cover 8, a roll-off piston 10 and an air spring flexible member 14. The air spring flexible member 14 is attached pressure-tight between the cover 8 and the piston 10 by means of clamp rings (12a, 12b). The shock absorber 6 is mounted on the longitudinal axis 16 of the air spring 4. The shock absorber 6 includes a shock absorber rod 18 and a shock absorber cylinder 20. The shock absorber rod 18 is connected force-tight to the air spring cover 8 and the shock absorber cylinder 20 is connected to the roll-off piston 10.

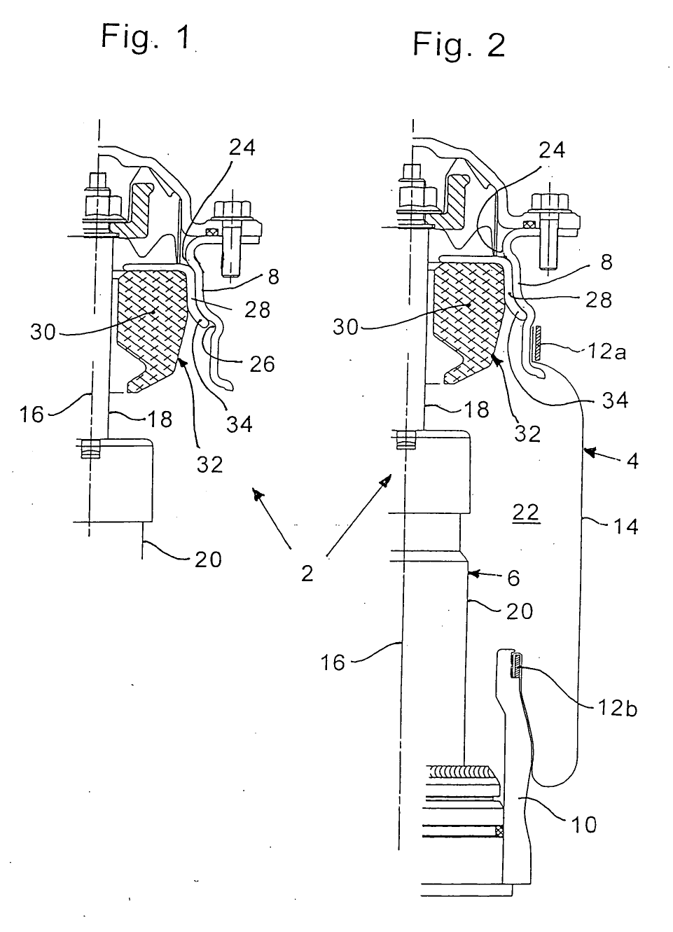

The air spring cover 8 is made of sheet metal and includes a side facing toward the air spring interior space 22. At this side, the air spring cover has a hollow-cylindrical geometry with a support 24 and a circumferentially-extending groove 26 for accommodating an ancillary spring 32. The ancillary spring 32 functions as a compression stop and comprises an ancillary spring pot 28 and a rubber bumper 30 and is generally referred to as an impact bumper. An edge 34 of the pot 28, which projects outwardly, is clamped in the groove 26 by a reduction of the diameter of the hollow-cylindrical region in the air spring cover 8. FIG. 1 shows the air spring cover 8 and pot 28 before clamping and FIG. 2 after clamping.

The forming process can be carried out by rolling. A rotating press roller deforms the material. During this operation, the clamping contour of the air spring cover 8 can be simultaneously rolled.

In the embodiment shown in FIGS. 1 and 2, the opposite-lying forms of the air spring cover 8 and the ancillary spring pot 28 are so configured that a forming process takes place simultaneously during clamping of the air spring flexible member 14 (clamp ring 12a) so that a separate rolling operation for clamping the ancillary spring pot to the air spring cover 8 is rendered unnecessary.

It is understood that the foregoing description is that of the preferred embodiments of the invention and that various changes and modifications may be made thereto without departing from the spirit and scope of the invention as defined in the appended claims.

What is claimed is:

1. An air spring comprising:
an air spring cover made of sheet metal;
a roll-off piston;
an air spring flexible member;
first and second clamp rings for clamping said flexible member pressure-tight to said air spring cover and said roll-off piston, respectively;
said air spring cover, said roll-off piston and said flexible member conjointly defining an air spring interior space;
said air spring cover having a side facing toward said interior space and said side defining a hollow cylindrical region of a first diameter;
a compression stop assembly mounted in said air spring cover and said compression stop assembly including an ancillary spring pot and an impact buffer disposed therein; and,
said ancillary spring pot having a second diameter and said first diameter being slightly greater than said second diameter.

2. The air spring of claim 1, said hollow cylindrical region defining a support; and, said ancillary spring pot being held in said support via a press fit.

3. The air spring of claim 2, wherein said pot has an outwardly formed edge; and, said hollow cylindrical region includes a circumferentially extending groove for receiving said edge therein.

4. The air spring of claim 1, wherein said air spring cover is made of steel sheet metal.

5. An air spring strut comprising:
an air spring cover made of sheet metal;
a roll-off piston;
an air spring flexible member;
first and second clamp rings for clamping said flexible member pressure-tight to said air spring cover and said roll-off piston, respectively;
said air spring cover, said roll-off piston and said flexible member conjointly defining an air spring interior space;
said air spring cover having a side facing toward said interior space and said side defining a hollow cylindrical region of a first diameter;
a compression stop assembly mounted in said air spring cover and said compression stop assembly including an ancillary spring pot and an impact buffer disposed therein;
said ancillary spring pot having a second diameter and said first diameter being slightly greater than said second diameter; and,
a shock absorber mounted in said interior space between said air spring cover and said roll-off piston.

6. A method for making an air spring which includes an air spring cover made of sheet metal; a roll-off piston; an air spring flexible member; first and second clamp rings for clamping said flexible member pressure-tight to said air spring cover and said roll-off piston, respectively; said air spring cover, said roll-off piston and said flexible member conjointly defining an air spring interior space; said air spring cover having a side facing toward said interior space and said side defining a hollow cylindrical region of a first diameter; a compression stop assembly mounted in said air spring cover and said compression stop assembly including an ancillary spring pot and an impact buffer disposed therein; said ancillary spring pot having a second diameter and said first diameter being slightly greater than said second diameter;
said pot having an outwardly formed edge; and,
said hollow cylindrical region including a circumferentially extending groove for receiving said edge therein; the method comprising the step of clamping said ancillary spring pot by reducing at least one of said cylindrical region of said air spring cover and the outer edge of said groove.

7. The method of claim 6, wherein said clamping step is carried in a forming process by rolling with a rotating press roller which deforms the material.

8. The method of claim 7, wherein the forming process for securing said ancillary spring pot takes place simultaneously with the rolling of a clamping contour of said air spring cover.

9. The method of claim 6, wherein said clamping for securing said ancillary spring pot takes place by clamping said flexible member with said first clamp ring.
